(19) United States
(12) Patent Application Publication
(10) Pub. No.: US 2016/0272210 A1
(43) Pub. Date: Sep. 22, 2016

(54) VEHICLE CONTROL DEVICE

(71) Applicant: TOYOTA JIDOSHA KABUSHIKI KAISHA, Toyota-shi (JP)

(72) Inventor: Koki MATSUSHITA, Mishima-shi (JP)

(73) Assignee: TOYOTA JIDOSHA KABUSHIKI KAISHA, Toyota-shi (JP)

(21) Appl. No.: 15/072,727

(22) Filed: Mar. 17, 2016

(30) Foreign Application Priority Data
Mar. 19, 2015 (JP) 2015-056531

(51) Int. Cl. B60W 30/188; B60W 10/06; B60W 10/02

(52) U.S. Cl. CPC B60W 30/1882; B60W 10/02; B60W 10/06; B60W 2510/06; B60W 2510/10; B60W 2400/00; B60W 2510/244; B60W 2710/06; B60W 2710/021

(57) ABSTRACT

A vehicle control device includes an engine, a battery, a starting device, a battery sensor, a crank angle sensor, a shift position sensor, and an electronic control unit. The electronic control unit is configured to determine whether or not at least either one of a piston position and a shift position satisfies a predetermined threshold switching condition based on the piston position and the shift position. The electronic control unit is configured to set the restart threshold to a first threshold in a case where it is determined that the threshold switching condition is not satisfied while the engine is automatically stopped. The electronic control unit is configured to set the restart threshold to a second threshold lower than the first threshold in a case where it is determined that the threshold switching condition is satisfied while the engine is automatically stopped.

### INCORPORATION BY REFERENCE

The disclosure of Japanese Patent Application No. 2015-056531 filed on Mar. 19, 2015 including the specification, drawings and abstract is incorporated herein by reference in its entirety.

### BACKGROUND OF THE INVENTION

1. Field of the Invention

The invention relates to a vehicle control device.

2. Description of Related Art

In the related art, a control device is known that automatically stops an engine in a case where, for example, it is detected that a driver releases his or her foot from an accelerator pedal when a vehicle is stopped or traveling of the vehicle is in progress.

For example, Japanese Patent Application Publication No. 2014-066222 (JP 2014-066222 A) discloses an idle stop control being executed when a vehicle speed is equal to or lower than a predetermined value and an idle stop condition is satisfied, even before the vehicle is stopped, so that a period during which the engine is automatically stopped is lengthened. JP 2014-066222 A also discloses excluding a satisfied item from an object with regard to object items included in the idle stop condition.

### SUMMARY OF THE INVENTION

However, the control device that is disclosed in JP 2014-066222 A is for executing the idle stop control and based on an assumption that the vehicle is stopped during the traveling. In other words, the control device that is disclosed in JP 2014-066222 A has a limited scope of application because the engine is automatically stopped and coasting of the vehicle is allowed when a predetermined condition is satisfied during the traveling at a certain or higher vehicle speed. Accordingly, there is room for development regarding a technique for lengthening the period of the automatic stop of the engine.

The invention provides a vehicle control device that is capable of improving fuel economy by lengthening a period during which an engine is automatically stopped.

A vehicle control device according to an aspect of the invention includes an engine, a battery, a starting device, a battery sensor, a crank angle sensor, a shift position sensor, and an electronic control unit. The starting device is configured to start the engine by consuming electric power of the battery. The battery sensor is configured to output a battery signal showing at least a voltage of the battery. The crank angle sensor is configured to output a crank angle signal showing a crank position of the engine. The shift position sensor is configured to output a shift signal showing a shift position. The electronic control unit is configured to allow the engine to be automatically stopped in a case where a predetermined engine stop condition is satisfied. The electronic control unit is configured to detect the voltage or a SOC of the battery based on the battery signal. The electronic control unit is configured to detect a piston position of the engine based on the crank angle signal. The electronic control unit is configured to detect the shift position based on the shift signal. The electronic control unit is configured to restart the engine in a case where an engine restart condition including the voltage or the SOC being lower than a restart threshold is satisfied. The electronic control unit is configured to determine whether or not at least either one of the piston position and the shift position satisfies a predetermined threshold switching condition based on the piston position and the shift position. The electronic control unit is configured to set the restart threshold to a first threshold in a case where it is determined that the threshold switching condition is not satisfied while the engine is automatically stopped. The electronic control unit is configured to set the restart threshold to a second threshold lower than the first threshold in a case where it is determined that the threshold switching condition is satisfied while the engine is automatically stopped.

In the vehicle control device according to the aspect described above, it is predicted that the amount of electric power consumption of the starting device during the restart of the engine is small by at least either one of the shift position and the piston position satisfying the threshold switching condition while the engine is automatically stopped. In a case where it can be predicted that the amount of the electric power consumption is small, the restart threshold of the engine restart condition is set to the second threshold lower than the normal first threshold (during the non-satisfaction of the threshold switching condition). Accordingly, in a case where the restart threshold is set to the second threshold, the engine can remain stopped until the battery voltage or the SOC falls short of the second threshold even in a case where the battery voltage or the SOC is lower than the first threshold, and thus a period during which the engine is allowed to be automatically stopped can become longer than in the case of the first threshold.

In the vehicle control device according to the aspect described above, the threshold switching condition may include the shift position being in a neutral range or a parking range. The electronic control unit may be configured to set the restart threshold to the second threshold in a case where the shift position is in the neutral range or the parking range.

In the vehicle control device according to the aspect described above, the transmission is in a neutral state and it can be predicted that the amount of the electric power consumption of the starting device during the restart of the engine is small in a case where the shift position is in the neutral range or the parking range. Accordingly, the restart threshold is set to the second threshold based on the shift position, and thus the period during which the engine is allowed to be automatically stopped can become longer than in the case of the first threshold.

In the vehicle control device according to the aspect described above, the vehicle control device may be further provided with a transmission and a clutch disposed in the middle of a power transmission path between the engine and the transmission. The electronic control unit may be configured to release the clutch and allow the engine to be automatically stopped in a case where the engine stop condition is satisfied. The threshold switching condition may include the piston position being a position other than a top dead center with an exhaust valve closed in an expansion stroke. The electronic control unit may be configured to set the restart threshold to the second threshold in a case where the piston position is the position other than the top dead center with the exhaust valve closed in the expansion stroke.

In the vehicle control device according to the aspect described above, it can be predicted that a load during the restart of the engine is small, that is, the amount of the electric power consumption of the starting device during the restart of the engine is small by fuel injection into a cylinder and ignition performed in a case where the piston position is the position other than the top dead center with the exhaust valve closed in the expansion stroke. Accordingly, the restart threshold is set to the second threshold based on the piston position, and thus the period during which the engine is allowed to be automatically stopped can become longer than in the case of the first threshold.

In the vehicle control device according to the aspect described above, the vehicle control device may be further provided with a transmission and a clutch disposed in the middle of a power transmission path between the engine and the transmission. The electronic control unit may be configured to release the clutch and allow the engine to be automatically stopped in a case where the engine stop condition is satisfied. The threshold switching condition may include the piston position being a position other than a top dead center with an exhaust valve closed in an expansion stroke and a temperature of cooling water of the engine being equal to or lower than a predetermined water temperature threshold. The electronic control unit may be configured to set a third threshold as the second threshold of the restart threshold in a case where the piston position is the position other than the top dead center with the exhaust valve closed in the expansion stroke and in a case where the temperature of the cooling water of the engine is not equal to or lower than the water temperature threshold. The electronic control unit may be configured to set a fourth threshold lower than the third threshold as the second threshold of the restart threshold in a case where the piston position is the position other than the top dead center with the exhaust valve closed in the expansion stroke and in a case where the temperature of the cooling water of the engine is equal to or lower than the water temperature threshold.

In the vehicle control device according to the aspect described above, it can be predicted that the cylinder has a low temperature inside and the cylinder has a high level of air density inside in a case where the temperature of the engine cooling water is equal to or lower than the water temperature threshold. Accordingly, it can be predicted that torque is generated in a state where combustion efficiency is at a high level during the restart of the engine. Accordingly, the third threshold or the fourth threshold lower than the first threshold is set as the second threshold of the restart threshold based on the temperature of the engine cooling water, and thus the period during which the engine is allowed to be automatically stopped can become longer than in the case of the first threshold. In addition, in a case where the engine cooling water has a temperature equal to or lower than the water temperature threshold, the period during which the engine is allowed to be automatically stopped can become longer than in the case of the third threshold by the restart threshold being set to the fourth threshold since the fourth threshold is lower than the third threshold.

In the vehicle control device according to the aspect described above, it is predicted that the electric power consumption of the starting device during the restart is small by either one of the shift position and the piston position satisfying the threshold switching condition and the restart threshold is set to the second threshold lower than the normal first threshold during the automatic stop of the engine. Accordingly, the engine remains automatically stopped in a case where the restart threshold with regard to the battery is reduced and the battery voltage or the SOC falls short of the first threshold but is higher than the second threshold. Accordingly, the period during which the engine is allowed to be automatically stopped can be lengthened.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a flowchart diagram illustrating a threshold switching control flow according to a first embodiment;

FIG. 2 is a flowchart diagram illustrating an engine restart control flow according to the first embodiment;

FIG. 3 is a time chart diagram illustrating how a battery voltage and electric power consumption change over time during an engine restart according to the first embodiment;

FIG. 4 is a schematic drawing illustrating a vehicle control device and a vehicle according to the first embodiment;

FIG. 5 is a flowchart diagram illustrating a threshold switching control flow according to a second embodiment;

FIG. 6 is a flowchart diagram illustrating an engine restart control flow according to the second embodiment;

FIG. 7 is a schematic drawing illustrating a vehicle control device and a vehicle according to the second embodiment; and

FIG. 8 is a flowchart diagram illustrating a threshold switching control flow according to a modification example of the second embodiment.

### DETAILED DESCRIPTION OF EMBODIMENTS

Hereinafter, a vehicle control device according to embodiments of the invention will be described in detail with reference to accompanying drawings.

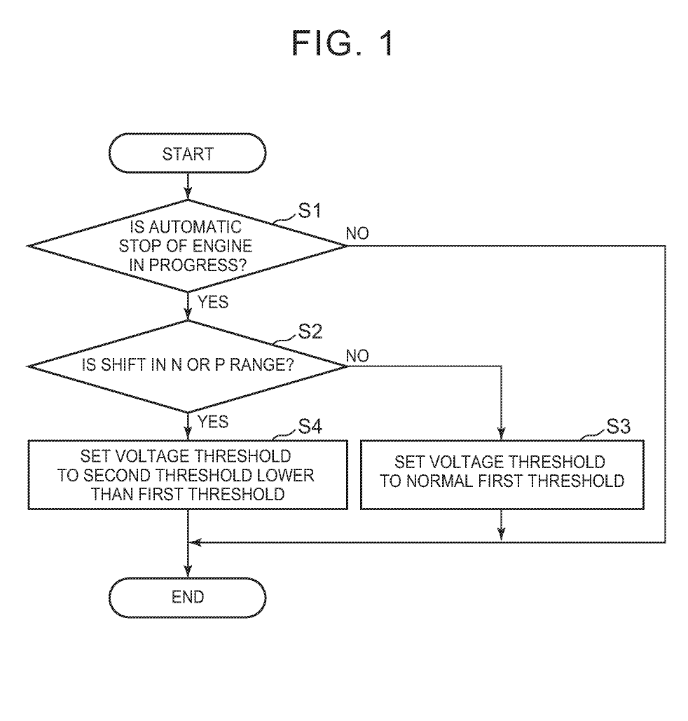

The vehicle control device according to a first embodiment will be described with reference to FIGS. 1 to 4.

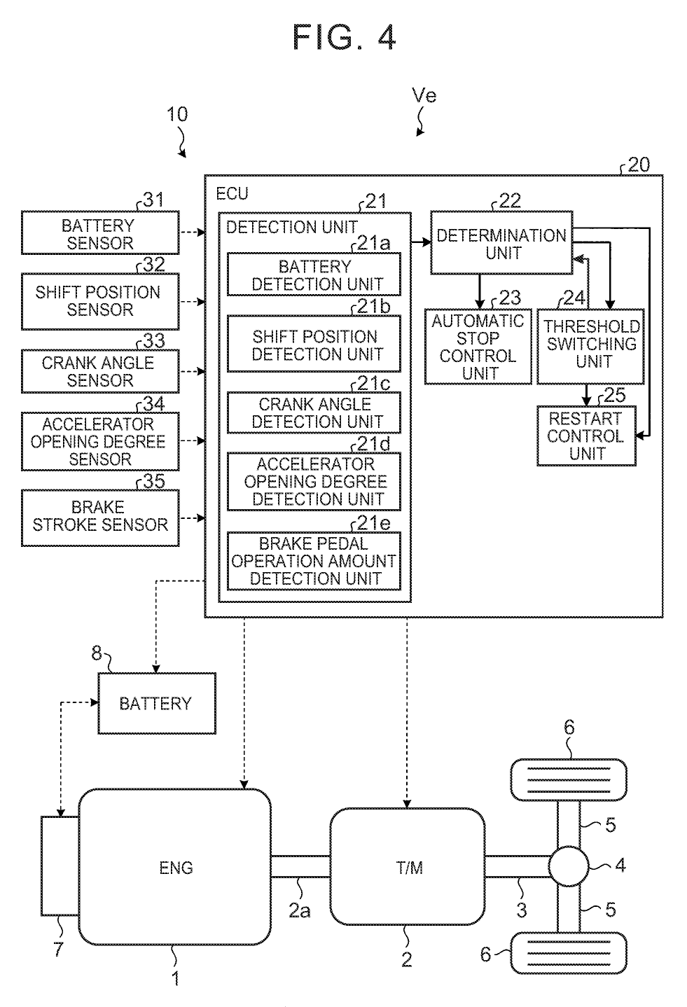

FIG. 4 is a schematic drawing illustrating the vehicle control device and a vehicle according to the first embodiment. A vehicle Ve that is an object of the first embodiment is provided, as a power train, with an engine (ENG) 1 which is a power source, an automatic transmission (T/M) 2, an output shaft 3, a differential 4, an axle 5, and drive wheels 6.

The engine 1 is a known internal combustion engine such as a gasoline engine and a diesel engine. The automatic transmission 2 is a known transmission that can automatically change a transmission gear ratio and can be automatically set into a neutral state. A crankshaft (not illustrated) of the engine 1 is connected to an input shaft 2a of the automatic transmission 2 to be capable of power transmission via a hydraulic power transmission (torque converter) causing a torque amplification effect based on a fluid flow. Accordingly, power output from the engine 1 (engine torque) is transmitted to the output shaft 3 via the automatic transmission 2. In addition, the output shaft 3 is connected to axle 5 to be capable of power transmission via the differential 4. Accordingly, transmission torque output from the engine 1 to the output shaft 3 via the automatic transmission 2 is transmitted to the drive wheels 6 via the differential 4 and the axle 5.

In addition, the vehicle Ve is provided with a starting device 7 that starts the engine 1 and a battery 8 that is a secondary battery. The battery 8 and the starting device 7 are connected to each other to be capable of electric power exchange via an inverter (not illustrated). The starting device 7 is a known starting device that is provided with a starter motor which cranks the engine 1 by consuming electric power of the battery 8. A rotor shaft of the starter motor that is included in the starting device 7 is connected to the crankshaft of the engine 1 to be capable of power transmission via a known power train (not illustrated) such as a belt mechanism.

As illustrated in FIG. 4, a vehicle control device 10 according to the first embodiment is provided with an electronic control unit (hereinafter, referred to as an “ECU”) 20 that controls the vehicle Ve. The ECU 20 is configured to have a microcomputer as a main component and executes calculation in accordance with a predetermined program based on input data and data stored in advance. Signals output from a battery sensor 31, a shift position sensor 32, a crank angle sensor 33, an accelerator opening degree sensor 34, and a brake stroke sensor 35 are input to the ECU 20.

The battery sensor 31 detects a voltage Vb of the battery 8 (hereinafter, referred to as a “battery voltage”), charge and discharge currents, and the like and outputs a battery signal. The shift position sensor 32 detects a current shift position such as a D range, an N range, and a P range and outputs a shift signal. The crank angle sensor 33 detects a crank position (crank angle) and an engine rotation speed (angular velocity of the crankshaft) and outputs a crank angle signal. The accelerator opening degree sensor 34 detects an accelerator pedal operation amount and outputs an accelerator opening degree signal. The brake stroke sensor 35 detects a brake pedal operation amount and outputs a brake signal. In addition, signals from a vehicle speed sensor (not illustrated) detecting a vehicle speed, a sensor (not illustrated) detecting a rotation speed of the input shaft 2a, and a sensor (not illustrated) detecting that the automatic transmission 2 is in the neutral state are input to the ECU 20.

The ECU 20 is provided with a detection unit 21 that detects the input signals from the respective sensors 31 to 35, a determination unit 22 that determines whether or not various conditions are satisfied based on a result of the detection by the detection unit 21, an automatic stop control unit 23 that allows the engine 1 to be automatically stopped, a threshold switching unit 24 that switches a threshold included in an engine restart condition (hereinafter, referred to as a “restart threshold”), and a restart control unit 25 that restarts the engine 1.

The detection unit 21 is provided with a battery detection unit 21a, a shift position detection unit 21b, a crank angle detection unit 21c, an accelerator opening degree detection unit 21d, and a brake pedal operation amount detection unit 21e. The battery detection unit 21a detects the battery voltage and a state of charge (SOC) of the battery 8 based on the battery signal from the battery sensor 31. The shift position detection unit 21b detects the shift position based on the shift signal from the shift position sensor 32. The crank angle detection unit 21c detects the crank angle and a piston position based on the crank angle signal from the crank angle sensor 33. The accelerator opening degree detection unit 21d detects the accelerator pedal operation amount and the presence or absence of a pedal operation based on the accelerator opening degree signal from the accelerator opening degree sensor 34. The brake pedal operation amount detection unit 21e detects the brake pedal operation amount and the presence or absence of a pedal operation based on the brake signal from the brake stroke sensor 35. The detection unit 21 may be configured to output results of the detection by the respective detection units 21a to 21e to the determination unit 22.

The determination unit 22 determines whether or not execution conditions for various types of controls are satisfied based on the detection result from the detection unit 21. In a case where it is determined by the determination unit 22 that a predetermined engine start condition is satisfied, for example, the automatic stop control unit 23 executes an engine stop control. In a case where it is determined by the determination unit 22 that a predetermined threshold switching condition is satisfied, the threshold switching unit 24 executes a threshold switching control. In a case where it is determined by the determination unit 22 that a predetermined engine restart condition is satisfied, the restart control unit 25 executes an engine restart control. These controls will be described in detail later.

The ECU 20 outputs a command signal based on results obtained by performing various types of calculation processing and controls devices mounted in the vehicle to be controlled (including the engine 1, the automatic transmission 2, the starting device 7, the battery 8, and the inverter). For example, the ECU 20 controls the amount of fuel supply to the engine 1, an intake air amount, fuel injection, an ignition timing, and the like. In addition, the ECU 20 is configured to be capable of executing a control for improving fuel economy by allowing the engine 1 to be automatically stopped depending on a vehicle state. This control includes controls referred to as a so-called stop-and-start control (S&S control), an eco-run control, an idle stop control, and the like. In the following description, these controls will be collectively referred to as the “S&S control”.

The automatic stop of the engine 1 based on the S&S control is temporary. The ECU 20 executes the engine stop control and the engine restart control by executing the S&S control. In short, during the S&S control, the engine stop control is executed and the engine 1 is automatically stopped by a predetermined execution condition (engine stop condition) being satisfied and the engine restart control is executed and the engine 1 is restarted by a predetermined return condition (engine restart condition) being satisfied. In the following description, the engine stop condition will be simply referred to as a “stop condition” and the engine restart condition will be simply referred to as a “restart condition”.

Specifically, in a case where the stop condition is satisfied from a result of the determination by the determination unit 22, the automatic stop control unit 23 executes a fuel cut control (hereinafter, referred to as a “F/C control”) for stopping the fuel injection into and ignition of the engine 1 as the engine stop control. In a case where the restart condition is satisfied during the automatic stop of the engine 1 from the result of the determination by the determination unit 22, the restart control unit 25 executes a start control for consuming the electric power of the battery 8 and rotating the crankshaft by using the starting device 7 as the engine restart control and restarts the engine 1.

The S&S control can be executed when the vehicle Ve is stopped or during traveling of the vehicle Ve. For example, the S&S control includes a stop S&S control for allowing the engine 1 to be automatically stopped while vehicle Ve is stopped to wait for a green light or the like, a deceleration S&S control for allowing the engine 1 to be automatically stopped while the vehicle Ve is decelerated to be stopped, and a free run S&S control for allowing the engine 1 to be automatically stopped during the traveling of the vehicle Ve at a certain or higher vehicle speed.

The stop S&S control is executed by the vehicle speed being “0” and a brake pedal being depressed (brake ON). A return is made by the brake pedal being returned (brake OFF), and then the engine 1 is restarted. The deceleration S&S control is executed by an accelerator pedal being returned (accelerator OFF) and the brake pedal being depressed (brake ON) during the traveling of the vehicle Ve at a vehicle speed equal to or lower than a predetermined vehicle speed. A return is made by the brake pedal being returned (brake OFF) or the accelerator pedal being depressed (accelerator ON), and then the engine 1 is restarted. The free run S&S control is executed by the accelerator pedal being returned (accelerator OFF) during the traveling of the vehicle Ve at a certain or higher vehicle speed. A return is made by the accelerator pedal being depressed (accelerator ON), and then the engine 1 is restarted.

As described above, the ECU 20 determines whether or not the stop condition or the restart condition is satisfied by using the determination unit 22 based on the signals from the accelerator opening degree sensor 34 and the brake stroke sensor 35 detected by the detection unit 21 (accelerator opening degree detection unit 21d and brake pedal operation amount detection unit 21e) and executes the S&S control based on a driver request (accelerator pedal operation and brake pedal operation). In addition, the automatic stop control unit 23 and the restart control unit 25 are configured to be capable of executing the S&S control based on a system requirement.

A case where the ECU 20 executes the engine restart control based on the battery voltage Vb will be described as an example of the S&S control based on the system requirement. The battery detection unit 21a detects the battery voltage Vb during the automatic stop of the engine based on the battery signal of the battery sensor 31 and the ECU 20 compares the restart threshold set as the restart condition by the determination unit 22 to the battery voltage Vb. In a case where the battery voltage Vb is lower than the restart threshold from the determination result of the determination unit 22 (in a case where the restart condition with regard to the battery voltage Vb is satisfied), the restart control unit 25 executes the engine restart control based on the system requirement.

The restart condition based on the system requirement includes the battery voltage Vb being lower than the restart threshold. This is because the starting device 7 restarts the engine 1 by consuming the electric power of the battery 8 and thus a voltage drop occurs in the battery 8 as a result of the electric power consumption. In this regard, the restart threshold with regard to the battery voltage Vb is set such that the battery voltage Vb does not fall short of a lower limit voltage Vₘᵢₙ during the restart of the engine. In addition, the magnitude of a load during the rotation of the crankshaft by the starting device 7 in accordance with the vehicle state during the restart of the engine (starting load) varies, and thus the magnitude of the electric power consumption varies depending on the starting load. Accordingly, in a case where it is predicted during the automatic stop of the engine that a small amount of electric power is required for the restart of the engine, the ECU 20 executes the threshold switching control for setting a lower-than-usual restart threshold with regard to the battery voltage Vb. In the following description, the restart threshold with regard to the battery voltage Vb will be referred to as a “voltage threshold”.

The execution condition for the threshold switching control (hereinafter, referred to as a “threshold switching condition”) includes the amount of the electric power that is predicted to be required for the restart of the engine being smaller than usual. In other words, the threshold switching condition includes the load during the cranking of the engine 1 by the starting device 7 being smaller than usual.

Specifically, the threshold switching condition includes the shift position being in the P range or the N range. When the crankshaft is rotated by the starting device 7, the starting load is smaller in a case where the automatic transmission 2 is in the neutral state than in a case where the automatic transmission 2 is not in the neutral state. In a case where the shift is in the P range, for example, rotation of the drive wheels 6 is regulated by a parking brake (not illustrated), and thus the automatic transmission 2 can be in the neutral state. The automatic transmission 2 is in the neutral state not only in a case where the shift is in the P range but also in a case where the shift is in the N range. In a case where the shift is in the D range, the automatic transmission 2 is in a state where power transmission is allowed, and thus the automatic transmission 2 is not in the neutral state. In other words, in a case where the shift is in the P range or the N range, the starting load is smaller than in a case where the shift is in the D range. In a case where the vehicle Ve is configured to be capable of being put into operation by an automatic operation system or the like, the engine restart control may be executed after the automatic transmission 2 is automatically and temporarily put into the neutral state.

Accordingly, the ECU 20 can determine whether or not the automatic transmission 2 is in the neutral state with the determination unit 22 and can predict a magnitude relationship regarding the starting load by the shift position detection unit 21b detecting the shift position based on the shift signal from the shift position sensor 32. Accordingly, in the case of the P range or the N range, the ECU 20 determines that the starting load is smaller and the electric power consumption is smaller than in the case of the D range, and the threshold switching unit 24 sets a voltage threshold lower than that in the case of the D range. The restart condition becomes looser than usual by the voltage threshold being set to be lower than usual as described above, and then the automatic stop of the engine can continue for a long period of time.

FIG. 1 is a flowchart diagram illustrating a threshold switching control flow according to the first embodiment. The control routine that is illustrated in FIG. 1 is repeatedly executed. The determination unit 22 determines whether or not the automatic stop of the engine is in progress (Step S1). In Step S1, it may be determined whether or not the execution of the S&S control (engine stop control) is in progress. In the case of a negative determination in Step S1 with the automatic stop of the engine not in progress, this control routine is terminated.

In the case of a positive determination in Step S1 with the automatic stop of the engine in progress, the determination unit 22 determines whether or not the shift position is in the P range or the N range (Step S2). The determination unit 22 determines whether or not the threshold switching condition with regard to the shift position is satisfied in Step S2.

In the case of a negative determination in Step S2 with the shift position not in the P range or the N range (for example, with the shift position in the D range), the threshold switching unit 24 sets the voltage threshold to a first threshold Vₜₕ₁ (Step S3). The first threshold Vₜₕ₁ is a normal voltage threshold (during the non-satisfaction of the threshold switching condition).

In the case of a positive determination in Step S2 with the shift position being in the P range or the N range, the threshold switching unit 24 sets the voltage threshold to a second threshold Vₜₕ₂ (Step S4). The second threshold Vₜₕ₂ is a voltage threshold that is lower than the first threshold Vₜₕ₁.

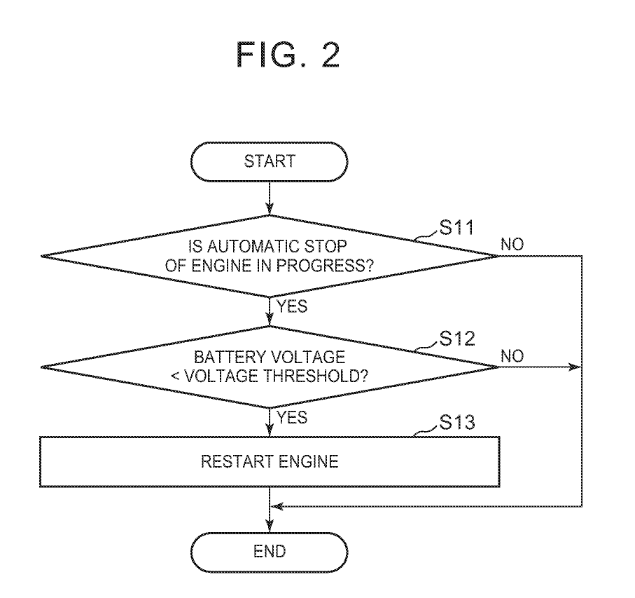

FIG. 2 is a flowchart diagram illustrating an engine restart control flow based on the system requirement. The control routine that is illustrated in FIG. 2 is repeatedly executed. The determination unit 22 determines whether or not the automatic stop of the engine (S&S control) is in progress (Step S11). In the case of a negative determination in Step S11 with the automatic stop of the engine not in progress, this control routine is terminated.

In the case of a positive determination in Step S11 with the automatic stop of the engine in progress, the determination unit 22 determines whether or not the battery voltage Vb is lower than the voltage threshold (Step S12). In the case of a negative determination in Step S12 with the battery voltage Vb equal to higher than the voltage threshold, this control routine is terminated.

In a case where the shift position is in the D range, for example, the voltage threshold is set to the first threshold Vₜₕ₁, and thus the determination unit 22 determines in Step S12 whether or not the battery voltage Vb is lower than the first threshold Vₜₕ₁. Alternatively, in a case where the shift position is in the N range or the P range, the voltage threshold is set to the second threshold Vₜₕ₂, and thus the determination unit 22 determines in Step S12 whether or not the battery voltage Vb is lower than the second threshold Vₜₕ₂.

In the case of a positive determination in Step S12 with the battery voltage Vb lower than the voltage threshold, the restart control unit 25 executes the engine restart control and the engine 1 is restarted by the starting device 7 (Step S13). The engine restart control in Step S13 is a control for restarting the engine 1 with the starting device 7 alone.

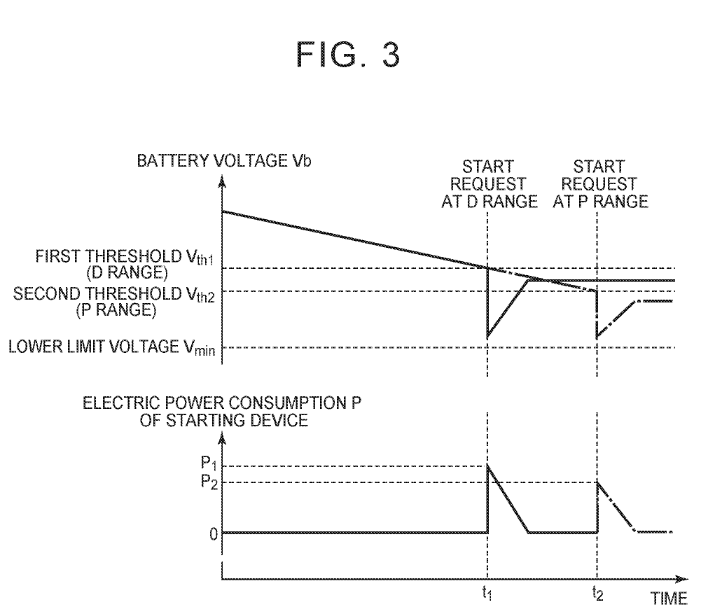

FIG. 3 is a time chart diagram illustrating how the battery voltage Vb and electric power consumption P change during the restart of the engine. The solid lines in FIG. 3 represent a case where the shift position is in the D range, and the one-dot chain lines in FIG. 3 represent a case where the shift position is in the P range. The vehicle state preceding a time t₁ illustrated in FIG. 3 shows that the automatic stop of the engine (S&S control) is in progress. The battery voltage Vb is reduced during the automatic stop of the engine. In a case where the shift position is in the D range, the voltage threshold is the first threshold Vₜₕ₁, and thus an engine restart request based on the system requirement is made (time t₁) upon the battery voltage Vb reaching the first threshold Vₜₕ₁ after being reduced. The restart condition is satisfied at the point in time of the time t₁, and thus a first starting electric power P₁ is consumed by the starting device 7 in the battery 8. The battery voltage Vb is reduced in accordance with the magnitude of the first starting electric power P₁. However, the battery voltage Vb does not fall short of the lower limit voltage Vₘᵢₙ.

In a case where the shift position is in the P range, the voltage threshold is the second threshold Vₜₕ₂, and thus the engine restart request based on the system requirement is made (time t₂) upon the battery voltage Vb reaching the second threshold Vₜₕ₂ after being reduced. The restart condition is satisfied at the point in time of the time t₂, and thus a second starting electric power P₂ is consumed by the starting device 7 in the battery 8. The battery voltage Vb is reduced in accordance with the magnitude of the second starting electric power P₂. However, the battery voltage Vb does not fall short of the lower limit voltage Vₘᵢₙ.

Herein, a case where the voltage threshold is set to the first threshold Vₜₕ₁ and a case where the voltage threshold is set to the second threshold Vₜₕ₂ will be compared to each other. Firstly, a comparison will be made with regard to an engine stop period. Because the time t₂ represents a point in time subsequent to the time t₁ with an engine stop time (S&S control initiation time) the same time, a period during which the engine 1 is automatically stopped is longer in a case where the voltage threshold is set to the second threshold Vₜₕ₂ than in a case where the voltage threshold is set to the first threshold Vₜₕ₁. In other words, the F/C control has an extended execution period, and thus the fuel economy is improved.

Next, a comparison will be made with regard to the electric power consumption P of the starting device 7. The second starting electric power P₂ in a case where the voltage threshold is set to the second threshold Vₜₕ₂ is smaller in amount than the first starting electric power P₁. This is because the load on the automatic transmission 2 during the restart of the engine is smaller in a case where the shift position is in the N range or the P range than in a case where the shift position is in the D range. In other words, the amount of drop in the battery voltage Vb during the restart of the engine is smaller in a case where the voltage threshold is set to the second threshold Vₜₕ₂ than in a case where the voltage threshold is set to the first threshold Vₜₕ₁.

As described above, in the vehicle control device according to the first embodiment, the restart threshold of the battery voltage is set to be lower than usual in a case where the shift position during the automatic stop of the engine is in the P range or the N range. Accordingly, the automatic stop period of the engine can become longer than in the related art, and the fuel economy of the vehicle can be improved.

In the first embodiment described above, the first threshold and the second threshold are set based on the threshold switching control. However, the threshold switching control may also be a control for setting only the second threshold. In other words, in a case where the first threshold is set in advance and the threshold switching condition is satisfied, the voltage threshold may be switched from the first threshold to the second threshold based on the threshold switching control. In this case, Step S3 of the above-described threshold switching control flow that is illustrated in FIG. 1 is omitted. In addition, a known method may be used as a method for setting the first threshold in advance.

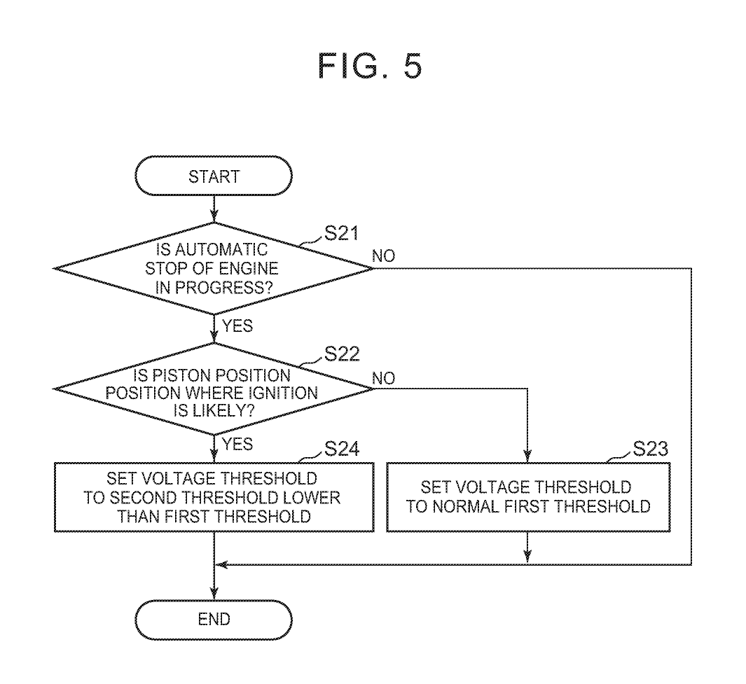

A vehicle control device according to a second embodiment will be described below with reference to FIGS. 5 to 7. In the second embodiment, the threshold switching control is executed based on the piston position of the engine 1 unlike in the first embodiment. In the following description of the second embodiment, description of configurations similar to those of the first embodiment will be omitted with the same reference numerals quoted.

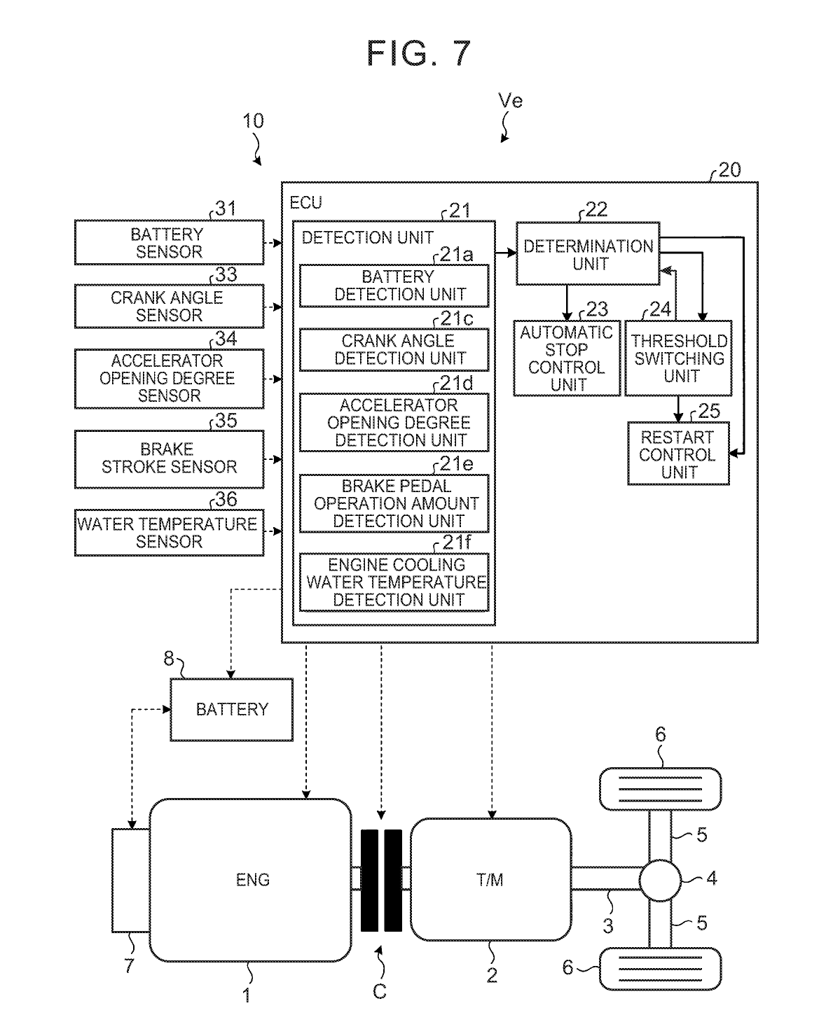

FIG. 7 is a schematic drawing illustrating the vehicle control device and a vehicle according to the second embodiment. The vehicle Ve is provided with a clutch C in the middle of a power transmission path between the engine 1 and the automatic transmission 2. The engine 1 has a direct-injection configuration. The clutch C is a friction-type clutch that can be selectively engaged or released. One friction engagement element of the clutch C is connected to the crankshaft of the engine 1, and the other engagement element is connected to the input shaft of the automatic transmission 2. In addition, the clutch C may be a hydraulic clutch that is operated by a hydraulic actuator, an electromagnetic clutch, or the like.

In the vehicle Ve, the engine 1 is disconnected from a power transmission system by the clutch C being released, and then the engine torque cannot be transmitted to the drive wheels 6. The engine 1 and the automatic transmission 2 are connected to each other to be capable of torque transmission by the clutch C being engaged, and then the engine torque can be transmitted to the drive wheels 6.

The starting device 7 is provided with a generator motor (hereinafter, referred to as an “MG”). This MG functions as the starter motor by being driven by the electric power that is supplied from the battery 8 and functions as a generator generating electric power by the rotor shaft being rotated by an external force acting thereon. The battery 8 can be charged with the electric power that is generated by the starting device 7. In other words, the SOC of the battery 8 is changed by the MG of the starting device 7 being allowed to function as the generator or the starter motor.

As illustrated in FIG. 7, the vehicle control device 10 is configured for a signal that is output from a water temperature sensor 36 to be input to the ECU 20. The water temperature sensor 36 detects a temperature of engine cooling water and outputs a water temperature signal. The detection unit 21 is provided with an engine cooling water temperature detection unit 21f that detects the temperature T of the engine cooling water based on the water temperature signal from the water temperature sensor 36. In addition, the ECU 20 is configured to execute a clutch control for selectively engaging or releasing the clutch C and an MG control for controlling the MG of the starting device 7. For example, the ECU 20 outputs a hydraulic command value for the clutch C to have a predetermined engaging force to the hydraulic actuator. In addition, the MG of the starting device 7 is allowed to function as the starter motor or the generator and the electric power exchange between the starting device 7 and the battery 8 is performed by the ECU 20 controlling the inverter (not illustrated). The battery detection unit 21a can detect the battery voltage Vb, the charge and discharge currents, an internal resistance, the SOC, and the like based on the battery signal input from the battery sensor 31. The ECU 20 may be configured to calculate the SOC based on the battery voltage Vb and the charge and discharge currents detected by the battery detection unit 21a.

For example, electric power generation by the MG of the starting device 7 is performed by the power that is output from the engine 1 being allowed to act on the rotor shaft of the MG. In addition, electric power generation (regenerative electric power generation) by the MG of the starting device 7 is performed by the external force from the drive wheel 6 side being allowed to act on the rotor shaft of the MG while the clutch C is engaged and the engine 1 is stopped. The battery 8 is charged with the electric power that is generated by the MG of the starting device 7. In this manner, the SOC of the battery 8 is changed.

In addition, the ECU 20 can detect the crank position (crank angle) and the piston position of each cylinder based on the input signal from the crank angle sensor 33 by using the crank angle detection unit 21c. The ECU 20 can perform fuel injection and ignition in an independent manner for each cylinder and performs a control such that the fuel injection and the ignition are performed once for each cylinder at every two crankshaft rotations. The vehicle control device 10 according to the second embodiment may be provided with no shift position sensor and shift position detection unit unlike that according to the first embodiment described above.

In a case where the stop condition is satisfied from the determination result of the determination unit 22, the ECU 20 releases the clutch C based on the control of the automatic stop control unit 23 and stops the fuel injection into and ignition of the engine 1 (allows the engine 1 to be automatically stopped). In addition, in a case where the restart condition is satisfied from the determination result of the determination unit 22, the ECU 20 engages the clutch C based on the control of the restart control unit 25 and resumes the fuel injection into and ignition of the engine 1. In other words, the automatic stop control unit 23 and the restart control unit 25 include functional means for executing the clutch control for selectively engaging or releasing the clutch C.

In a case where the free run S&S control is carried out with the stop condition satisfied during the traveling of the vehicle Ve at a high vehicle speed, for example, the clutch C is released and the F/C control is carried out, and then coasting (free run) of the vehicle Ve is allowed. By the clutch C being released during the free run S&S control, the drive wheels 6 do not drag and rotate the engine 1, and thus the vehicle Ve can have an extended coasting distance. Accordingly, the fuel economy can be improved.

In addition, in a case where the restart condition is satisfied during the engine restart control by the restart control unit 25, the fuel injection into and ignition of the engine 1 are performed in conjunction with the cranking by the starting device 7 and the engine 1 is started. An ignition start for rotating the crankshaft with combustion energy resulting from fuel ignition is performed instead of the restart of the engine by the starting device 7 alone. Accordingly, the electric power consumption P during the start of the engine can be more suppressed in the case of the ignition start in conjunction with the start of the engine by the starting device 7 than in a case where the restart of the engine is performed by the starting device 7 alone.

The method for starting the engine with the restart control unit 25 may be a method for starting the engine based solely on the fuel injection into and ignition of the engine 1, that is, based solely on the combustion energy without using the starting device 7. In a case where the engine 1 is restarted only through the ignition start as described above, the amount of the electric power consumption P attributable to the starting device 7 can be suppressed. In short, the vehicle control device 10 according to the second embodiment is configured to perform at least the ignition start in a case where the restart condition is satisfied.

In a case where the piston position is a position where the fuel ignition is likely in view of the result of the detection by the crank angle detection unit 21c, the load during the restart of the engine is small. In this regard, the piston position of a certain cylinder of the engine 1 being the position where the fuel ignition (ignition) is likely is the threshold switching condition.

The threshold switching condition includes the piston position being a position other than a top dead center (TDC) with an exhaust valve closed in an expansion stroke. In other words, the determination unit 22 can determine that the threshold switching condition is satisfied in a case where all the conditions of being in the expansion stroke, not being at the top dead center, and the cylinder being in a sealed state inside before the exhaust valve is opened are satisfied. In addition, it is preferable that the piston position satisfying the threshold switching condition is not in the vicinity of the top dead center. The vicinity of the top dead center can be expressed as a range equivalent to one from the top dead center for an intake stroke to closing of the exhaust valve.

During the S&S control, the clutch C is released and the piston position is not displaced since the F/C control is in progress. For example, during the traveling of the vehicle Ve as well as in a state where the vehicle Ve is stopped, the engine 1 is not dragged and rotated by the drive wheels 6 by the clutch C remaining released, and thus the piston position is not displaced. In addition, the ECU 20 may be configured to be capable of executing a control for controlling the MG of the starting device 7 based on the crank angle signal detected by the crank angle detection unit 21c and displacing the piston position into the range suitable for the ignition described above during the automatic stop of the engine.

FIG. 5 is a flowchart diagram illustrating a threshold switching control flow according to the second embodiment. The control routine that is illustrated in FIG. 5 is repeatedly executed. The determination unit 22 determines whether or not the automatic stop of the engine is in progress (Step S21). In the case of a negative determination in Step S21 with the automatic stop of the engine not in progress, this control routine is terminated.

In the case of a positive determination in Step S21 with the automatic stop of the engine in progress, the determination unit 22 determines whether or not the piston position is the position where the ignition is likely (Step S22). In Step S22, the determination unit 22 determines whether or not the piston position satisfies the threshold switching condition. In other words, in Step S22, the determination unit 22 determines, based on the crank angle signal detected by the crank angle detection unit 21c, whether or not the piston position is the position other than the top dead center with the exhaust valve closed in the expansion stroke.

In the case of a negative determination in Step S22 with the piston position not being the position where the ignition is likely, the threshold switching unit 24 sets the voltage threshold to the first threshold Vₜₕ₁ (Step S23). The first threshold Vₜₕ₁ in Step S23 is a normal voltage threshold. The piston position not being the position where the ignition is likely includes a case where the piston position is the top dead center in the expansion stroke, a case where the piston position is in the vicinity of a bottom dead center, and the like.

In the case of a positive determination in Step S22 with the piston position being the position where the ignition is likely, the threshold switching unit 24 sets the voltage threshold to the second threshold Vₜₕ₂ (Step S24). The second threshold Vₜₕ₂ is a voltage threshold that is lower than the first threshold Vₜₕ₁.

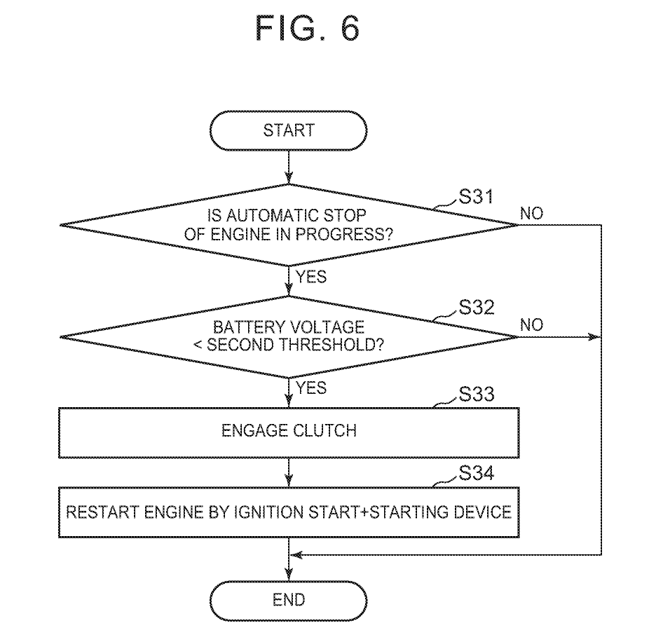

FIG. 6 is a flowchart diagram illustrating a system requirement-based engine restart control flow pertaining to a case where the restart threshold is set to the second threshold Vₜₕ₂. The control routine that is illustrated in FIG. 6 is repeatedly executed. The determination unit 22 determines whether or not the automatic stop of the engine is in progress (Step S31). In the case of a negative determination in Step S31 with the automatic stop of the engine not in progress, this control routine is terminated.

In the case of a positive determination in Step S31 with the automatic stop of the engine in progress, the determination unit 22 determines whether or not the battery voltage Vb is lower than the second threshold Vₜₕ₂ (Step S32). In the case of a negative determination in Step S32 with the battery voltage Vb not lower than the second threshold Vₜₕ₂, this control routine is terminated.

In the case of a positive determination in Step S32 with the battery voltage Vb lower than the second threshold Vₜₕ₂, the restart control unit 25 engages the clutch C (Step S33), executes the ignition start and the engine restart control based on the starting device 7, and restarts the engine 1 (Step S34). In Step S34, the fuel injection and ignition are performed on the cylinder determined to be positive in Step S22 described above, that is, the cylinder with the piston position satisfying the threshold switching condition. During the engine restart control in Step S34, the engine 1 may be restarted through the ignition start alone.

As described above, in the vehicle control device according to the second embodiment, the restart threshold of the battery voltage is set to be lower than usual in a case where the piston position is the position where the ignition is likely. Accordingly, the automatic stop of the engine continues for an extended period of time, and the fuel economy can be improved.

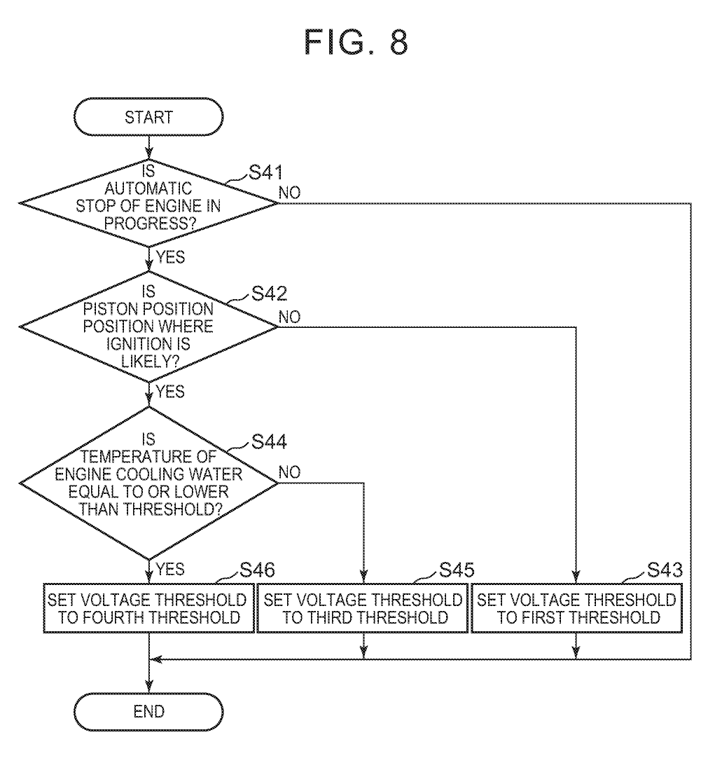

Hereinafter, the vehicle control device 10 according to a modification example of the second embodiment will be described with reference to FIG. 8. This modification example is configured for two types of thresholds with different setting conditions to be set as the second threshold Vₜₕ₂ unlike in the second embodiment. In the following description of this modification example, description of configurations similar to those of the second embodiment will be omitted with the same reference numerals quoted.

This modification example is configured to use two conditions, one being the threshold switching condition with regard to the piston position (hereinafter, referred to as a “first switching condition”) and the other one being the threshold switching condition with regard to the temperature T of the engine cooling water (hereinafter, referred to as a “second switching condition”). This is because the cylinder has a higher level of air density inside, efficiency of the combustion energy resulting from the ignition is at a higher level, the output torque increases, and the electric power consumption P of the starting device 7 decreases as the temperature T of the engine cooling water becomes lower. Accordingly, the second switching condition includes the temperature T of the engine cooling water being equal to or lower than a predetermined water temperature threshold. The first switching condition includes the piston position being the position where the combustion ignition is likely (such as the position other than the top dead center TDC with the exhaust valve closed in the expansion stroke) as in the second embodiment.

Specifically, in a case where only the first switching condition is satisfied out of the first and second switching conditions from the determination result of the determination unit 22, the threshold switching unit 24 sets the voltage threshold to a third threshold Vₜₕ₃. In a case where both the first and second switching conditions are satisfied from the determination result of the determination unit 22, the threshold switching unit 24 sets the voltage threshold to a fourth threshold Vₜₕ₄. In short, the threshold switching condition is satisfied when only the first switching condition is satisfied, and then the third threshold Vₜₕ₃ or the fourth threshold Vₜₕ₄, each of which is lower than the first threshold Vₜₕ₁, can be set as is the case with the second threshold Vₜₕ₂ described above. In addition, the fourth threshold Vₜₕ₄, which is lower than the third threshold Vₜₕ₃, can be set by the second switching condition being satisfied.

In short, in this modification example, the threshold switching unit 24 sets the voltage threshold to the third threshold Vₜₕ₃ or the fourth threshold Vₜₕ₄ instead of the above-described second threshold Vₜₕ₂ in a case where the piston position satisfies the first switching condition in view of the determination result of the determination unit 22. In other words, although a voltage threshold that is lower than the first threshold is set in this modification example as well, this voltage threshold includes the two types of thresholds with the different setting conditions, that is, the third threshold Vₜₕ₃ and the fourth threshold Vₜₕ₄.

FIG. 8 is a flowchart diagram illustrating a threshold switching control flow according to this modification example. Step S41 in FIG. 8 is similar to Step S21 in FIG. 5. Step S42 in FIG. 8 is similar to Step S22 in FIG. 5. Step S43 in FIG. 8 is similar to Step S23 in FIG. 5.

In the case of a positive determination in Step S42 with the piston position the position where the ignition is likely (first switching condition: satisfied), the determination unit 22 determines whether or not the temperature T of the engine cooling water is equal to or lower than the water temperature threshold (Step S44). In Step S44, the determination unit 22 determines whether or not the second switching condition is satisfied. For example, the water temperature threshold in Step S44 is a predetermined value that is equal to or higher than a water temperature threshold included in the stop condition (water temperature allowing the S&S) and is lower than a water temperature in a complete warm-up state. This water temperature threshold may be set in advance.

In the case of a negative determination in Step S44 with the temperature T of the engine cooling water not being equal to or lower than the water temperature threshold (first switching condition: satisfied, second switching condition: not satisfied), the threshold switching unit 24 sets the voltage threshold to the third threshold Vₜₕ₃ (Step S45). The third threshold Vₜₕ₃ is a voltage threshold that is lower than the first threshold Vₜₕ₁. In other words, even when the second switching condition is not satisfied (Step S44: No), the threshold switching unit 24 sets the voltage threshold to be lower than usual.

In the case of a positive determination in Step S44 with the temperature T of the engine cooling water being equal to or lower than the water temperature threshold (first switching condition: satisfied, second switching condition: satisfied), the threshold switching unit 24 sets the voltage threshold to the fourth threshold Vₜₕ₄ (Step S46). The fourth threshold Vₜₕ₄ is a voltage threshold that is lower than the third threshold Vₜₕ₃. In other words, in a case where both the first and second switching conditions are satisfied (Step S44: Yes), the threshold switching unit 24 sets the voltage threshold to be lower than usual and to be lower than in a case where only the piston position is satisfied.

As described above, in the vehicle control device according to the modification example of the second embodiment, the voltage threshold that is included in the restart condition is set to be lower than usual in a case where the engine cooling water has a low temperature. Accordingly, the period during which the engine is automatically stopped can be lengthened, and thus the fuel economy can be improved.

The vehicle control device according to the invention is not limited to each of the above-described embodiments and modification example, and can be appropriately changed without departing from the object of the invention.

For example, the invention may be a vehicle control device in which the first embodiment, the second embodiment, and the modification example of the second embodiment are combined with one another. In other words, the vehicle control device according to the invention may be configured to set the voltage threshold to be lower in a case where at least either one of the shift position and the piston position satisfies the threshold switching condition than in a case where the threshold switching condition is not satisfied. In addition, the invention allows a combination between the power train of the vehicle described above and the various types of controls described above. For example, the invention may be configured to execute the various types of controls described in the first embodiment on the vehicle in which the clutch described in the second embodiment is mounted.

The vehicle control device according to the invention may be configured to use the SOC of the battery, instead of the battery voltage according to each of the embodiments and the modification example described above, as a determination parameter. In short, a restart threshold with regard to the SOC may be included in the restart condition. In other words, the restart condition is satisfied in a case where the battery voltage is lower than the voltage threshold or in a case where the SOC is lower than a SOC threshold (restart threshold with regard to the SOC). For example, the above-described battery voltage can be replaced with the SOC and the voltage threshold can be replaced with the SOC threshold. Specifically, the threshold switching unit 24 sets the SOC threshold to a normal first threshold SOCₜₕ₁ in a case where the threshold switching condition is not satisfied and sets the SOC threshold to a second threshold SOCₜₕ₂, which is lower than the first threshold SOCₜₕ₁, in a case where the threshold switching condition is satisfied. The determination unit 22 can determine whether or not the engine restart condition is satisfied by determining whether or not the SOC detected by the battery detection unit 21a is lower than the SOC threshold (restart threshold). In a case where it is determined by the determination unit 22 that the SOC is lower than the SOC threshold during the automatic stop of the engine, the restart control unit 25 executes the engine restart control.

What is claimed is:

1. A vehicle control device comprising:
an engine;
a battery;
a starting device configured to start the engine by consuming electric power of the battery;
a battery sensor configured to output a battery signal showing at least a voltage of the battery;
a crank angle sensor configured to output a crank angle signal showing a crank position of the engine;
a shift position sensor configured to output a shift signal showing a shift position; and
an electronic control unit configured to allow the engine to be automatically stopped in a case where a predetermined engine stop condition is satisfied, the electronic control unit being configured to detect the voltage or a SOC of the battery based on the battery signal, the electronic control unit being configured to detect a piston position of the engine based on the crank angle signal, the electronic control unit being configured to detect the shift position based on the shift signal, the electronic control unit being configured to restart the engine in a case where an engine restart condition including the voltage or the SOC being lower than a restart threshold is satisfied, the electronic control unit being configured to determine whether or not at least either one of the piston position and the shift position satisfies a predetermined threshold switching condition based on the piston position and the shift position, the electronic control unit being configured to set the restart threshold to a first threshold in a case where it is determined that the threshold switching condition is not satisfied while the engine is automatically stopped, and the electronic control unit being configured to set the restart threshold to a second threshold lower than the first threshold in a case where it is determined that the threshold switching condition is satisfied while the engine is automatically stopped.

2. The vehicle control device according to claim 1,
wherein the threshold switching condition includes the shift position being in a neutral range or a parking range, and
wherein the electronic control unit is configured to set the restart threshold to the second threshold in a case where the shift position is in the neutral range or the parking range.

3. The vehicle control device according to claim 1, further comprising:
a transmission; and
a clutch disposed in the middle of a power transmission path between the engine and the transmission,
wherein the electronic control unit is configured to release the clutch and allow the engine to be automatically stopped in a case where the engine stop condition is satisfied,
wherein the threshold switching condition includes the piston position being a position other than a top dead center with an exhaust valve closed in an expansion stroke, and
wherein the electronic control unit is configured to set the restart threshold to the second threshold in a case where the piston position is the position other than the top dead center with the exhaust valve closed in the expansion stroke.

4. The vehicle control device according to claim 1, further comprising:
a transmission; and
a clutch disposed in the middle of a power transmission path between the engine and the transmission,
wherein the electronic control unit is configured to release the clutch and allow the engine to be automatically stopped in a case where the engine stop condition is satisfied,
wherein the threshold switching condition includes the piston position being a position other than a top dead center with an exhaust valve closed in an expansion stroke and a temperature of cooling water of the engine being equal to or lower than a predetermined water temperature threshold,
wherein the electronic control unit is configured to set a third threshold as the second threshold of the restart threshold in a case where the piston position is the position other than the top dead center with the exhaust valve closed in the expansion stroke and in a case where the temperature of the cooling water of the engine is not equal to or lower than the water temperature threshold, and
wherein the electronic control unit is configured to set a fourth threshold lower than the third threshold as the second threshold of the restart threshold in a case where the piston position is the position other than the top dead center with the exhaust valve closed in the expansion stroke and in a case where the temperature of the cooling water of the engine is equal to or lower than the water temperature threshold.
